(19) United States
(12) Patent Application Publication
(10) Pub. No.: US 2013/0275041 A1
(43) Pub. Date: Oct. 17, 2013

(54) METHOD FOR CREATING A MAP FOR USE IN A TWO-WAY RADIO DEVICE

(71) Applicant: SHIN-TSENG YEH, New Taipei City (TW)

(72) Inventor: SHIN-TSENG YEH, New Taipei City (TW)

(73) Assignee: Unication Group/Unication Co., LTD., New Taipei City (TW)

(21) Appl. No.: 13/448,593

(22) Filed: Apr. 17, 2012

(51) Int. Cl. G01C 21/00

(52) U.S. Cl. 701/461

(57) ABSTRACT

A method of creating a map for use in a two-way radio device, includes steps of: a. creating a map template by downloading from a personal computer (PC) or scanning a map sheet; b. receiving coordinates of at least two reference points through a Global Positioning System (GPS) by the PC; c. correspondingly marking and combining the at least two reference points on and with the map template through a map edit program so as to create at least a geographic drawing in electronic format, which is stored in a map database of the PC; d. providing a map data file for the two-way radio device for storing geographic drawings searched from the map database; and e. retrieving a desired geographic drawing from the geographic drawings by the two-way radio device, and displaying the desired geographic drawing on a screen of the two-way radio device to enable the GPS positioning.

### BACKGROUND OF THE INVENTION

1. Field of the Invention

The present invention relates to a method of creating a map, and particularly to a method of creating a map for use in a two-way radio device (or so called walkie-talkie) that is capable of selecting a desired geographic map stored in the two-way radio device.

2. Related Art

A traditional two-way radio (or so called walkie-talkie, including an analog/digital radio system) for public safety or specialized people (e.g. policemen, fire fighters, security officers, medical teams, rescue teams) is generally not equipped with a Global Positioning System (GPS) or display function. Since the GPS has been widely used in portable electronic products (e.g. mobile phones, note book computers) or vehicles, certain traditional radios are improved to add the GPS function to provide location information or a historical track record to other people for a purpose of indicating a final location or a proceeding path.

However, such GPS radios often receive their own GPS positions to locate themselves, and can concurrently transmit location information to a control center or other people's communication devices. For functions mentioned above, users have to purchase or rent a soft program or a corresponding map from certain suppliers. Unfortunately, the maps provided from the certain suppliers are probably not suitable for a small region, a building, or a restricted area, such as a market of a city, school, office building, governmental or military organization. As a result, a rescue team (such as policemen, fire fighters, or the military) is unable to control a correct and precise location and therefore fail to efficiently carry out the operation.

### SUMMARY OF THE INVENTION

Accordingly, an object of the present invention is to provide a method of creating a map at any time for use in a two-way radio device in order for a rescue team to carry out a rescue operation, and particularly to a method of creating a map that is unable to provided by a supplier of satellite navigation system or a Global Positioning System (GPS).

To achieve the above object, the present invention provides a method of creating a map for use in a two-way radio device, comprising steps of: a. creating a map template by downloading from a personal computer (PC) or scanning a map sheet, the map template being temporarily stored in a processor of the PC; b. receiving coordinates of at least two reference points through a Global Positioning System (GPS) by the PC, the coordinates of the at least two reference points being temporarily stored in the processor; c. correspondingly marking and combining the at least two reference points on and with the map template through a map edit program so as to create at least a geographic drawing in electronic format, which is stored in a map database of the PC; d. providing a map data file for the two-way radio device for storing a plurality of geographic drawings searched from the map database of the PC; and e. retrieving a desired geographic drawing from the plurality of geographic drawings of the map database by the two-way radio device, and displaying the desired geographic drawing on a screen of the two-way radio device to enable the GPS positioning.

With the above mentioned method, the at least a geographic drawing is prepared and generated in advance for a jurisdictional area or any emergency situation by a dispatch center or mobile command station utilizing the PC. The at least a geographic drawing is stored in the map database of the PC and is capable of being transmitted to a two-way radio device of a user through the wireless communication system of the two-way radio device or through a cable in order to perform functions of positioning and indication and further improve working efficiency.

### BRIEF DESCRIPTION OF THE DRAWINGS

FIG. 1 is a flow chart of a method of creating a map for use in a two-way radio device of the present invention.

FIG. 2 is a schematic view showing reference points and a group of users using the two-way radio device at a geographic area.

FIG. 3 is a flow chart showing how a geographic drawing is created.

FIG. 4 is a schematic view showing the geographic drawing displayed on a screen of the two-way radio device.

FIG. 5 is a plan view of a building where location sensors are distributed at.

FIG. 6 is a schematic view showing that FIG. 5 is appropriately displayed on a screen of a personal computer.

### DESCRIPTION OF THE PREFERRED EMBODIMENTS

For better and further knowledge and understanding of the device and efficacy of the present invention, embodiments are hereby given with detailed descriptions in cooperation with the attached drawings below.

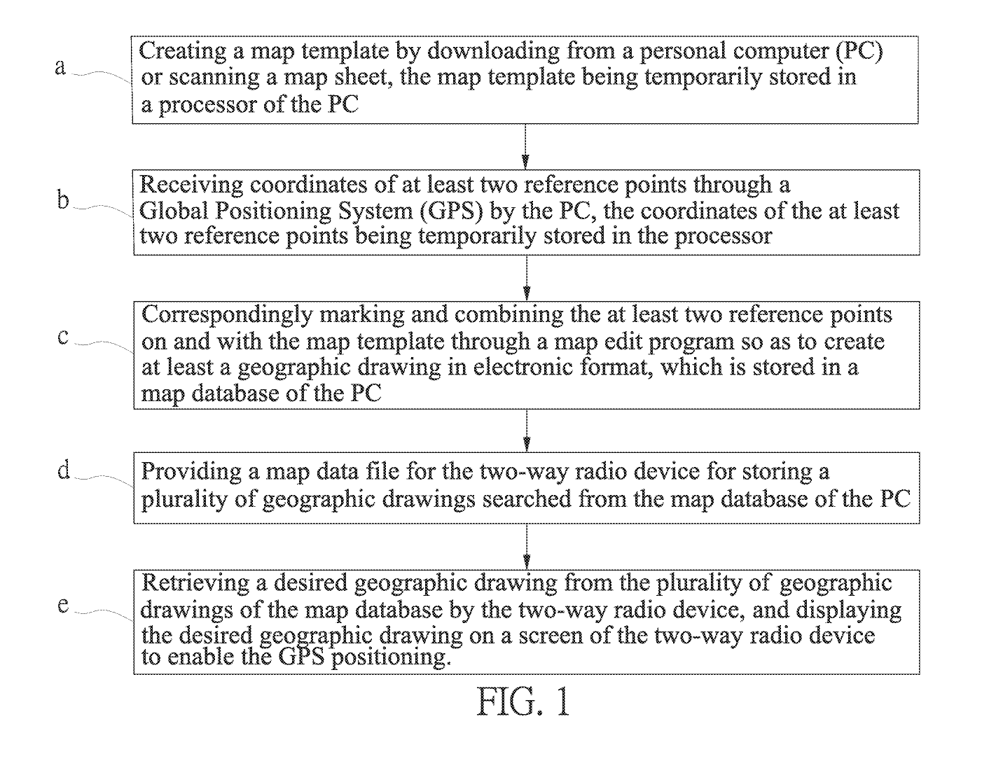

Referring to FIG. 1 showing a flow chart of a method of creating a map for use in a two-way radio device of the present invention, the method comprises steps as follows: step a: creating a map template by downloading from a personal computer (PC) or a control console or scanning a map sheet, the map template being temporarily stored in a processor of the PC; step b: receiving coordinates of at least two reference points through a Global Positioning System (GPS) by the PC, the coordinates of the at least two reference points being temporarily stored in the processor; step c: correspondingly marking and combining the at least two reference points on and with the map template through a map edit program so as to create at least a geographic drawing in electronic format, which is stored in a map database of the PC (or in a server of the control console); step d: providing a map data file for the two-way radio device for storing a plurality of geographic drawings searched from the map database of the PC; and step e: retrieving a desired geographic drawing from the plurality of geographic drawings being searched by the two-way radio device, and displaying the desired geographic drawing on a screen of the two-way radio device to enable the GPS positioning.

The at least a geographic drawing in electronic format of the step C is capable of being converted to a radio format according to frequency of the two-way radio device in order to be transmitted with a wireless communication system to the two-way radio device. Furthermore, in the step d the geographic drawings stored in the map data file are downloaded through the wireless communication system of the two-way radio device or through a cable. The map data file includes a currently new created map file and a previous stored file or a used historical map data file.

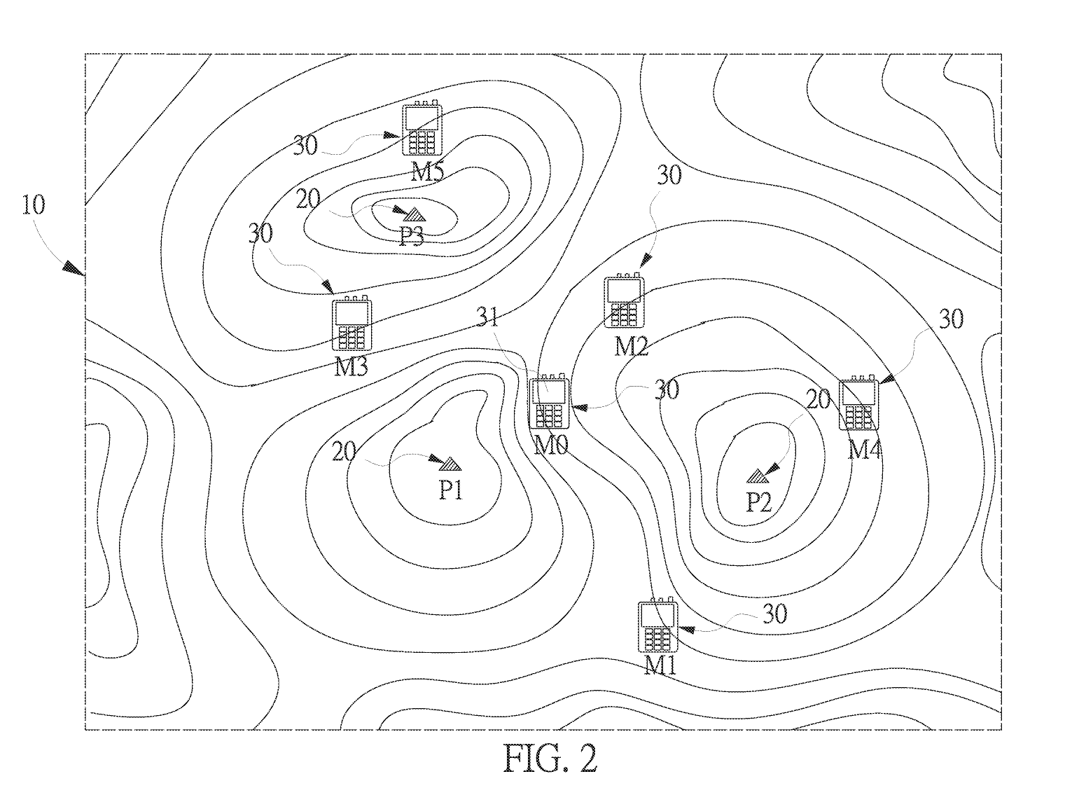

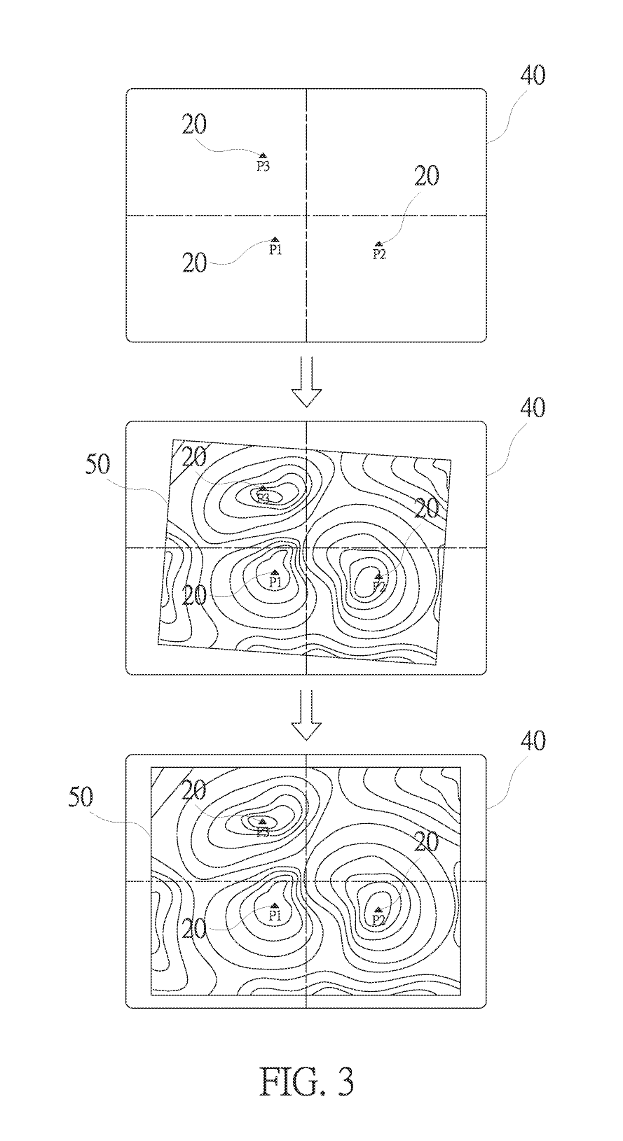

Referring to FIGS. 2 and 3, FIG. 2 is an actual scene of a geographic area 10 where three reference points 20 (P1-P3) and a group of users using the two-way radio device 30 (M0-M5) are distributed at. The three reference points 20 are displayed on a screen 40 of the PC with the coordinates of the three reference points 20 and a scale preset by a program. Next, the map template 50 created in the step a is correspondingly combined and overlapped with the three reference points 20 (P1-P3)on a screen 40 of the PC. Then, move the map template 50 or one reference point P1 of the three reference points 20 to correspond with each other in position and to match the actual scene of the geographic area of FIG. 2. After the reference point P1 is located in place, the map template 50 is being adjusted in scale and angle to allow the other reference points 20 (P2-P3) to be correspondingly located in place, and then determine and set a scale and angle of the map template 50. As a result, with the map template 50, the geographic drawing in electronic format is created and corresponds to the actual scene of the geographic area 10, and is stored in a map database of the PC (not shown). Finally, proceed to the steps d and e of the method of the present invention, wherein the plurality of geographic drawings are applicable to the radio device 30 having a positioning program for use of a group position and indication, checking historical track records, or temporary positioning.

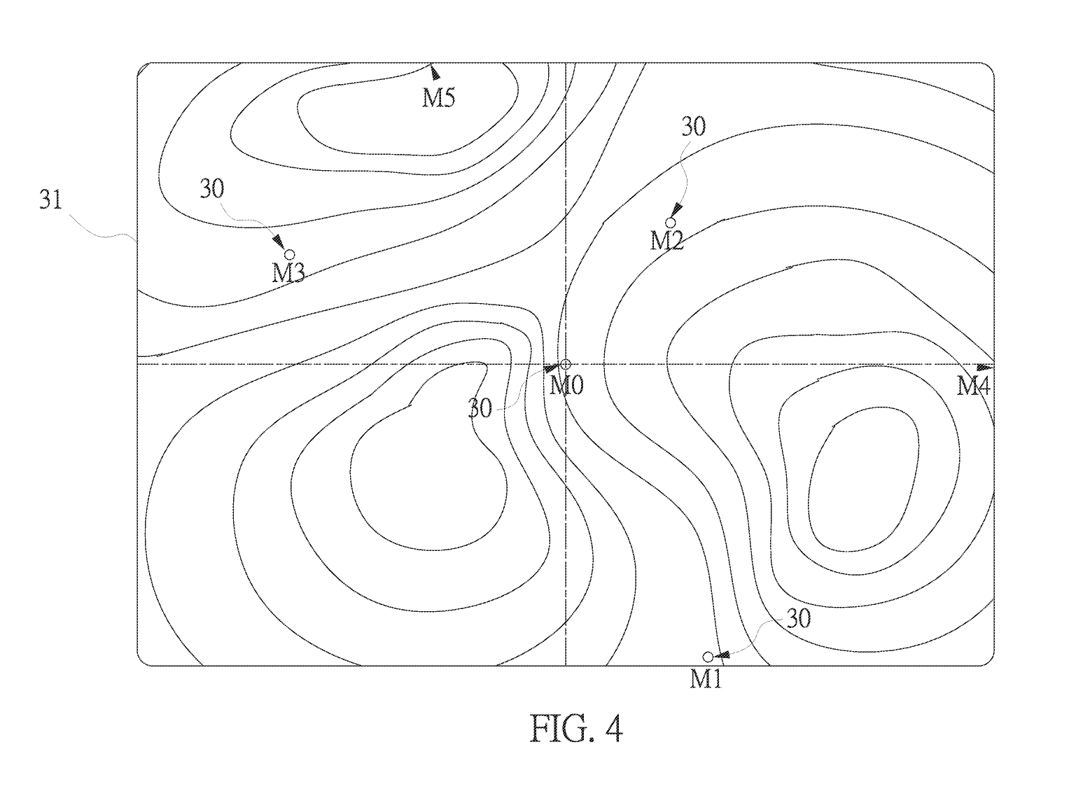

Referring to FIG. 4, when performs functions of positioning and indicating, the two-way radio device 30 first receives its own coordinate information, then retrieves a map created with the method of the present invention from a memory of the two-way radio device 30, and displays the map on a screen 31 of the two-way radio device 30, wherein a location of the two-way radio device 30 is being centered on the map (M0 represents the two-way radio device 30 in FIG. 4), and actively invites or is passively invited by other users to participate in a same group positioning system. Coordinate information of other users (M1-M3) received by the two-way radio device 30 is correspondingly indicated on a same image (arrows of M4 M5 shown on peripheral sides of the screen 31 in FIG. 4 means that there are other users located outside of an indication range). That is, the two-way radio device 30 is capable of showing related locations of the device 30 and other users concurrently. Furthermore, the two-way radio device 30 has other functions, such as tracking, checking, recording, or deleting records.

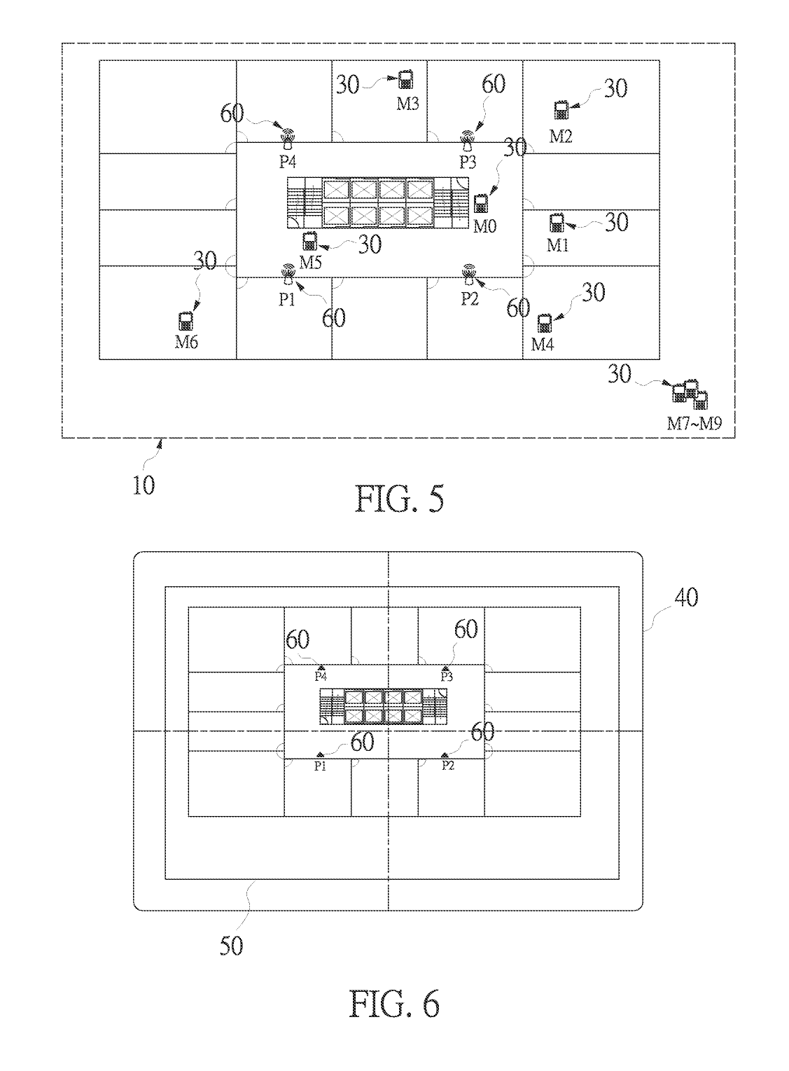

Referring to FIG. 5 showing another embodiment of the present invention, the step b of the method further provides a short-range transceiver module (not shown) for receiving signals from multiple location sensors 60, and then calculate coordinate information of the location sensors 60 as reference points, which are temporarily stored in the processor of the PC.

Locations of the short-range transceiver module being capable of using technology of Wireless Fidelity (Wi-Fi), bluetooth, ZigBee, or Radio-frequency identification (RFID) tags, and the location sensors 60 (such as beacons, WAPs or RF tags) in a building are known in advance (as shown in FIG. 5, P1-P4), whereby coordinate information of the location sensors 60 can be calculated by triangulation according to radio signal strength indication (RSSI) among the location sensors 60, and is temporarily stored in the processor of the PC. Referring to FIG. 6, next step is to follow the step c of the method to adjust a scale and angle of the map template 50, so as to allow a location of each of the location sensors 60 to be correspondingly located in place on the screen 40 of the PC and reflected on the map template 50, whereby a geographic drawing in electronic format is created and stored in the map database of the PC. Finally, following the steps d and e to transmit the geographic drawing to the two-way radio device 30 used by each user of the group (as M0-M9, and console) through the wireless communication system or through a cable.

Accordingly, the method of creating a map for use in a two-way radio device of the present invention allows a group of users using the two-way radio device to create useful and appropriate maps for use and support for any emergency situation.

It is understood that the invention may be embodied in other forms within the scope of the claims. Thus the present examples and embodiments are to be considered in all respects as illustrative, and not restrictive, of the invention defined by the claims.

What is claimed is:

1. A method of creating a map for use in a two-way radio device, comprising steps of:
a. creating a map template by downloading from a personal computer (PC) or scanning a map sheet, the map template being temporarily stored in a processor of the PC;
b. receiving coordinates of at least two reference points through a Global Positioning System (GPS) by the PC, the coordinates of the at least two reference points being temporarily stored in the processor;
c. correspondingly marking and combining the at least two reference points on and with the map template through a map edit program so as to create at least a geographic drawing in electronic format, which is stored in a map database of the PC;
d. providing a map data file for the two-way radio device for storing a plurality of geographic drawings searched from the map database of the PC; and
e. retrieving a desired geographic drawing from the plurality of geographic drawings of the map database by the two-way radio device, and displaying the desired geographic drawing on a screen of the two-way radio device to enable the GPS positioning.

2. The method of claim 1, wherein the coordinates of the at least two reference points and the map template are displayed on a screen of the PC, and the map template or one of the at least two reference points is moved to correspond with each other in position, wherein after the one of the at least two reference points is located in place, the map template is being adjusted in scale and angle to allow others of the at least two reference points to be correspondingly located in place, and then a scale and angle of the map template are determined, whereby the at least a geographic drawing in electronic format is created.

3. The method of claim 1, wherein the at least a geographic drawing in electronic format is capable of being converted to a radio format.

4. The method of claim 1, wherein in the step d the geographic drawings stored in the map data file are downloaded through a wireless communication system of the two-way radio device or through a cable by the radio device.

5. The method of claim 1, wherein the step b further provides a short-range transceiver module for receiving signals from at least two location sensors, and then calculate coordinate information of the at least two location sensors as coordinate information of reference points.

6. The method of claim 5, wherein the at least two location sensors are distributed in a known area.

7. The method of claim 5, wherein the short-range transceiver module is capable of using technology of Wireless Fidelity (Wi-Fi), bluetooth, ZigBee, or Radio-frequency identification (RFID) tags.
